(19) United States
(12) Patent Application Publication
(10) Pub. No.: US 2007/0123324 A1
(43) Pub. Date: May 31, 2007

(54) Portable communication terminal

(75) Inventors: Shigemasa Sato, Yokohama-shi (JP); Takuya Shirahata, Yokohama-shi (JP)

Correspondence Address: OLIFF & BERRIDGE, PLC, P.O. BOX 19928, ALEXANDRIA, VA, 22320, US

(73) Assignee: NIKON CORPORATION, TOKYO (JP)

(21) Appl. No.: 11/604,030

(22) Filed: Nov. 24, 2006

(30) Foreign Application Priority Data
Nov. 30, 2005 (JP) 2005-345185

(51) Int. Cl. H04M 1/00

(52) U.S. Cl. 455/575.3

(57) ABSTRACT

Opening/closing operation is detected at a portable communication terminal that includes an opening/closing mechanism and upon predicting the occurrence of a shock resulting from at least one of the opening operation and the closing operation, the head of a hard disk drive is retracted to a safe position so as to prevent damage to the disk and the head.

### INCORPORATION BY REFERENCE

The disclosure of the following priority application is herein incorporated by reference:

Japanese Patent Application No. 2005-345185 filed Nov. 30, 2005

### BACKGROUND OF THE INVENTION

1. Field of the Invention

The present invention relates to a portable communication terminal equipped with a hard disk drive.

2. Description of the Related Art

A portable telephone equipped with a hard disk (model name: SPH-V5400), developed and manufactured for practical use by Samsung Electronics, has been available on the Korean market.

In a communication device known in the related art (see Japanese Laid Open Patent Publication No. 2003-179671), a vibrator operation and a recording/reproducing operation at a hard disk drive are executed as mutually exclusive operations by holding the head of the hard disk drive at a predetermined retracted position so as to prevent a hard disk drive malfunction due to vibration.

The inventor of the present invention conducted concentrated research into various causes of damage to hard disk drives. The research has revealed that the hard disk drive in a portable communication terminal with an opening/closing mechanism, a typical example of which is a folding-type portable telephone, is not fully protected against shock occurring as the user performs an opening/closing operation.

### SUMMARY OF THE INVENTION

A portable communication terminal according to the present invention comprises a first body unit, a second body unit, an opening/closing mechanism used to open/close the first body unit and the second body unit relative to each other, a hard disk drive at which data written onto a disk by using a head are stored, a predicting device that detects opening operation/closing operation of the opening/closing mechanism and predicts occurrence of a shock attributable to at least one of the opening operation and the closing operation, and a control device that retracts the head of the hard disk drive to a safe position so as to ensure that neither the disk nor the head becomes damaged, based upon a prediction of occurrence of shock by the predicting device.

The predicting device may detect the opening operation of the opening/closing mechanism by detecting that the opening/closing mechanism, having been in a closed state, has become opened by a predetermined extent. The predicting device may detect the closing operation of the opening/closing mechanism by detecting that the opening/closing mechanism, having been in a open state, has become closed by a predetermined extent.

The opening/closing mechanism may be any of; a mechanism that opens/closes by allowing the first body unit and the second body unit to slide relative to each other, a mechanism that opens/closes by allowing the first body unit and the second body unit to fold relative to each other and a mechanism that opens/closes by allowing the first body unit and the second body unit to twist relative to each other.

The portable communication terminal can further comprises a state detection device that detects at least one of an open state and a closed state of the opening/closing mechanism. In this case, the control device may set the head of the hard disk drive at a position at which write to disk is enabled, if the state detection device detects the open state or the closed state of the opening/closing mechanism. Likewise, the control device may set the head of the hard disk drive at a position at which read from disk is enabled, if the state detection device detects the open state or the closed state of the opening/closing mechanism.

The portable communication terminal can further comprises a state detection device that detects at least one of an open state and a closed state of the opening/closing mechanism. In this case, if the state detection device detects the open state or the closed state at the opening/closing mechanism while the head is held at the safe position, the control device may move the head of the hard disk drive to a position at which a write into the disk is enabled. Likewise, if the state detection device detects the open state or the closed state at the opening/closing mechanism while the head is held at the safe position, the control device may move the head of the hard disk drive to a position at which a read from the disk is enabled.

The predicting device may include a detection device that detects the opening operation/closing operation of the opening/closing mechanism. In this case, the detection device can include an acceleration sensor.

In the portable communication terminal, the predicting device may include an acceleration sensor. If the opening/closing mechanism opens/closes as the first body unit and the second body unit are allowed to fold relative to each other, the acceleration sensor can be disposed at least at one of an end of the first body unit located on a side opposite from a rotational center of the opening/closing mechanism and an end of the second body unit located on a side opposite from the rotational center of the opening/closing mechanism. If the opening/closing mechanism opens/closes as the first body unit and the second body unit are allowed to twist relative to each other, the acceleration sensor can be disposed at least at one of an end of the first body unit located on a side opposite from a center of a rotating motion of the opening/closing mechanism and an end of the second body unit located on a side opposite from the center of the rotating motion of the opening/closing mechanism.

The portable communication terminal may further comprises a switching device that switches a data storage location to an external storage device connected via a wireless communication device based upon a prediction of occurrence of shock by the predicting device.

The portable communication terminal may further comprises an image-capturing device that captures an image. Image data obtained by capturing the image at the image-capturing device can be stored into the hard disk drive.

### BRIEF DESCRIPTION OF THE DRAWINGS

FIG. 1 schematically illustrates the structure of a folding-type portable telephone embodying the portable communication terminal;

FIG. 2 is a block diagram of the structure adopted in the portable telephone in the embodiment;

FIG. 3 presents a specific example of the open state detection switch;

FIG. 4 schematically illustrates the relationship among the opening angle (closing angle) at the portable telephone, the on/off state of the open state detection switch and the on/off state of the closed state detection switch;

FIG. 5 presents a flowchart of the processing executed in the portable telephone;

FIG. 6 schematically illustrates a specific example of a sliding-type portable telephone;

FIG. 7 schematically illustrates a specific example of a rotating-type portable telephone; and

FIG. 8 shows how an acceleration sensor may be installed in a portable telephone.

### DETAILED DESCRIPTION OF THE PREFERRED EMBODIMENTS

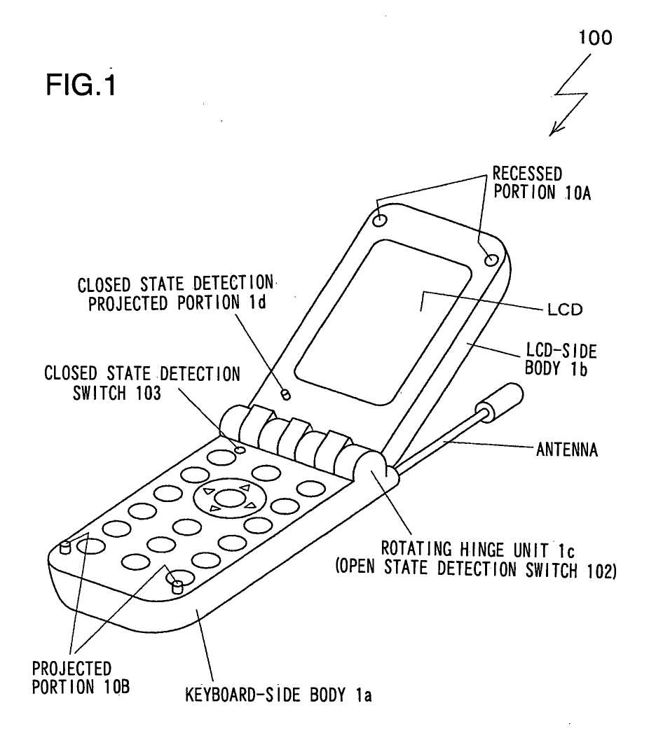

FIG. 1 schematically illustrates the structure of a portable telephone embodying the portable communication terminal. A portable telephone 100 includes a rotating hinge unit 1c to function as an opening/closing mechanism, disposed between a keyboard-side body 1a (a first body unit) and an LCD-side body 1b (a second body unit). Namely, the portable telephone 100 is a folding-type portable telephone that can be folded along an axis at the rotating hinge unit 1c.

A camera module (camera) is mounted at the portable telephone 100 on the rear side of the LCD surface at the LCD-side body 1b. The portable telephone 100 also includes a built-in hard disk drive (HDD), disposed one of in the keyboard-side body 1a and in the LCD-side body 1b, at which data written into a disk thereof via a head are stored. Image data of images captured with the camera and various other types of data can be stored at the HDD. The HDD is constituted with a magnetic head and a disk (neither shown). The disk is coated with a magnetic material. The magnetic head of the HDD writes data onto the disk and reads data written on the disk through electromagnetic induction.

Every time the user performs an opening/closing operation at the portable telephone 100 with the opening/closing mechanism (collapsible mechanism) described above, impact noise and shock (vibration) attributable to the opening/closing operation will occur. As described earlier, the portable telephone 100 in the embodiment includes a built-in hard disk drive. Such a hard disk drive is likely to be vulnerable to shock, which may damage the head and the disk. In particular, a shock occurring during a data read or a data write, i.e., while the head at the hard disk drive is accessing the disk, is more likely to result in a hard disk drive malfunction. Thus, it is an essential requirement that any hard disk drive malfunction attributable to a shock resulting from an opening/closing operation be prevented in the portable telephone.

The portable telephone 100 includes projected portions 10B at the keyboard-side body 1a and recessed portions 10A, to fit with the projected portions 10B, at the LCD-side body 1b. The impact noise that occurs as the portable telephone is opened/closed is reduced by forming the recessed portions 10A with an elastic material such as rubber. While the impact noise resulting from the opening/closing operation is effectively reduced with the projected portions 10B and the recessed portions 10A, it does not reduce the extent of shock resulting from the opening/closing operation to a sufficient degree.

Accordingly, in the portable telephone 100 achieved in the embodiment, access to the hard disk drive becomes disallowed upon detecting an opening/closing operation performed by the user to open/close the portable telephone 100, on the assumption that the portable telephone 100 is about to be subjected to a shock. Namely, the head of the hard disk drive is retracted to a safe position so as to ensure that neither the disk nor the head is damaged.

The safe position to be assumed by the head to ensure that the head and the disk remain undamaged, as described above, is a position at which the head and the disk cannot come into contact with each other. Accordingly, the head may be driven to the safe position to ensure that neither the head nor the disk becomes damaged by moving the head along the horizontal direction relative to the disk to a position outside the range of the disk. Alternatively, the head may be retracted to a position set over a distance from the disk by driving it along a direction perpendicular to the disk.

As a result, by the time the portable telephone 100 is subjected to a shock from the opening/closing operation performed by the user, the head is already at the retracted position at which it does not come into contact with the disk to cause damage. Thus, the hard disk drive is protected from shock and hard disk drive malfunction is prevented.

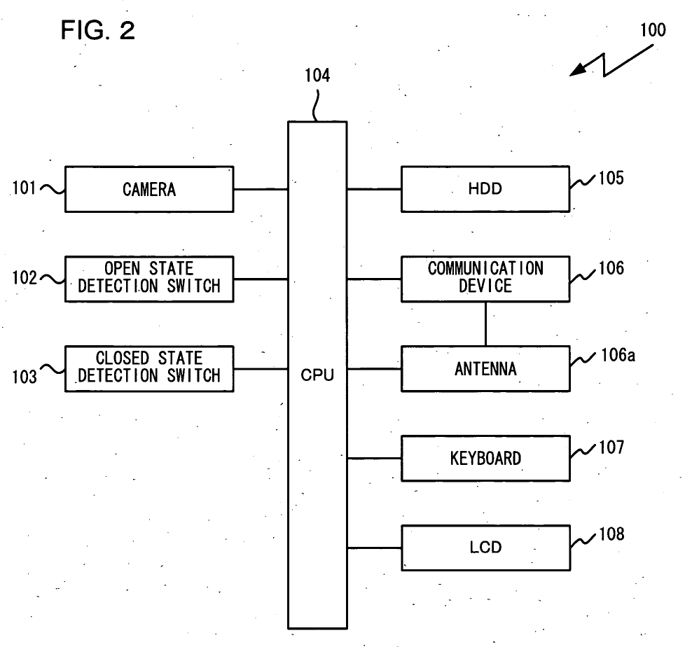

FIG. 2 is a block diagram of the structure adopted in the portable telephone 100 in the embodiment. The portable telephone 100 comprises a camera 101, an open state detection switch 102, a closed state detection switch 103, a CPU 104, an HDD 105, a communication device 106, a keyboard 107 and an LCD 108.

The camera 101, constituted with a lens and an image-capturing element such as a CCD, captures a subject image input thereto via the lens and outputs image data obtained through the image capturing operation to the CPU 104. The open state detection switch 102 and the closed state detection switch 103 each output an ON signal to the CPU 104 as it is turned on, as explained later. The communication device 106 includes an antenna 106a and engages in communication with a portable telephone base station. The keyboard 107 is an input device disposed on the keyboard-side body 1a, whereas the LCD 108 is a display device disposed on the LCD-side body 1b.

The CPU 104 writes image data input thereto from the camera 101 into the HDD 105. Access to the HDD 105 for the data write is controlled by detecting signals input from the open state detection switch 102 and the closed state detection switch 103, as explained below.

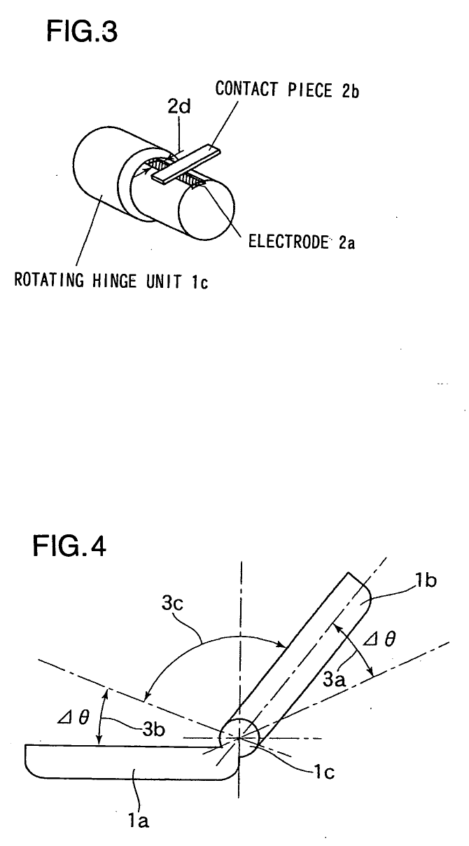

The open state detection switch 102, which is built into the rotating hinge unit 1c, detects that the portable telephone 100 is in an open state, i.e., the keyboard-side body 1a and the LCD-side body 1b are in an open state, by detecting the rotational state of the rotating hinge unit 1c. FIG. 3 presents a specific example of the open state detection switch 102. FIG. 3 shows the open state detection switch 102 constituted with an electrode 2a disposed at the keyboard-side body 1a within the rotating hinge unit 1c and a contact piece 2b disposed at the LCD-side body 1b within the rotating hinge unit 1c. The electrode 2a and the contact piece 2b are set so that they come into contact with each other when the portable telephone 100 is in an open state. While the electrode and the contact piece are in contact with each other, the open state detection switch 102 remains in an ON state and outputs a signal to the CPU 104.

It is to be noted that the electrode 2a has a width 2d that assures contact between the electrode 2a and the contact piece 2b even when the portable telephone 100 in a fully open state starts to close until the closing angle becomes equal to a predetermined angle Δθ. In other words, the open state detection switch 102 is designed so as to sustain an ON state until the portable telephone 100 having been in the fully open state is folded to achieve the predetermined closing angle Δθ. This means that the open state detection switch 102 is designed to enter an ON state as the portable telephone 100 in the closed state is opened, only when its opening angle becomes shy of the full open state by the predetermined angle Δθ.

The closed state detection switch 103 detects that the portable telephone 100 is in a closed state, i.e., the keyboard-side body 1a and the LCD-side body 1b are in a closed state. The closed state detection switch 103 is disposed at the keyboard-side body 1a. As the keyboard-side body 1a and the LCD-side body 1b are folded one on top of the other and the portable telephone 100 enters a closed state, the closed state detection switch 103 is pressed down by a closed state detection projected portion 1d disposed at the LCD-side body 1b shown in FIG. 1 and the closed state detection switch 103 thus enters an ON state.

It is to be noted that the closed state detection projected portion 1d has a length that allows the closed state detection switch 103 to sustain an ON state even when the portable telephone 100 in the closed state starts to open, until the opening angle becomes equal to the predetermined angle Δθ. In other words, the closed state detection switch 103 is designed to enter an ON state as the portable telephone 100 in the open state is closed, only when the opening angle becomes shy of the fully closed state by the predetermined angle Δθ.

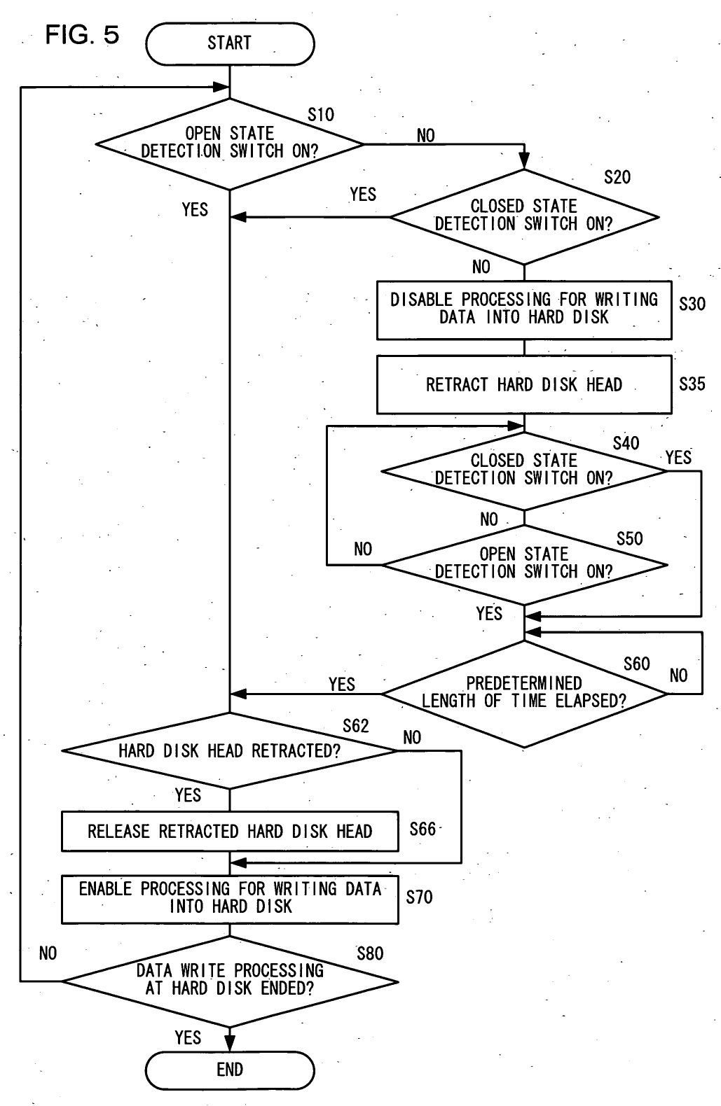

FIG. 4 schematically illustrates the relationship among the opening angle (closing angle) of the portable telephone 100, the on/off state of the open state detection switch 102 and the on/off state of the closed state detection switch 103. When the opening angle at the portable telephone 100 is within a range 3a, the open state detection switch 102 is in an ON state and the closed state detection switch 103 is in an OFF state. When the opening angle at the portable telephone 100 is within a range 3b, on the other hand, the open state detection switch 102 is in an OFF state and the closed state detection switch 103 is in an ON state. In addition, when the opening angle at the portable telephone 100 is within a range 3c, the open state detection switch 102 and the closed state detection switch 103 are both in an OFF state.

The CPU 104 monitors signals input from the open state detection switch 102 and the closed state detection switch 103 and controls the head of the HDD 105 based upon the input signals. Namely, the CPU 104 executes control so as to position the head of the HDD 105 at a data write/read enabled position when the signal input from either the open state detection switch 102 or the closed state detection switch 103 is in an ON state.

At the data write enabled position, the head assumes a standby position at which any data that need to be actually written can be written immediately. At the data read enabled position, the head assumes a standby position at which any data that need to be actually read out can be read immediately. In other words, the CPU 104 allows image data input from the camera 101 to be written into the HDD 105 or image data to be read out from the HDD 105.

If the CPU 104 detects a shift from an ON state to an OFF state in either of the signals input from the open state detection switch 102 and the closed state detection switch 103, the CPU 104 judges that the user has performed an opening operation or a closing operation for the portable telephone 100. Under such circumstances, the portable telephone 100 is expected to be subjected to a shock as soon as the operation is completed and the portable telephone is set in an open state or a closed state. Accordingly, data write and data read at the HDD 105 are disabled and the head of the HDD 105 is retracted to the safe position so that neither the head nor the disk will be damaged due to shock.

It is to be noted that the open state detection switch 102 sustains an ON state until the portable telephone 100 having been in the fully open state becomes folded by the predetermined angle Δθ as described earlier. Accordingly, the CPU 104 detects the closing operation by the user when the portable telephone 100 having been in the fully open state becomes folded by the predetermined extent. In addition, the closed state detection switch 103 sustains an ON state until the portable telephone 100 having been in the fully closed state becomes open by the predetermined angle Δθ. Thus, the CPU 104 detects the opening operation by the user as the portable telephone 100 having been in the fully closed state becomes open by the predetermined extent. In other words, if the user briefly applies a force along the opening direction or the closing direction resulting in a slight change in the opening angle of the portable telephone 100, the change is not erroneously detected as an opening operation or a closing operation.

After detecting an opening operation of the portable telephone 100 by the user and disallowing data write and read at the HDD 105, the CPU 104 enables data write and read at the HDD 105 upon judging that the portable telephone 100 has entered the fully open state or the fully closed state based upon the signals input from the open state detection switch 102 or the closed state detection switch 103. Namely, the CPU 104 resets the head of the HDD 105 at the data write/read enabled position over the disk and resumes data write/read at the HDD 105.

After detecting a closing operation of the portable telephone 100 by the user and disallowing data write and read at the HDD 105, the CPU resumes the data write and read at the HDD 105 upon judging that the portable telephone 100 has entered the fully open state or the fully closed state based upon the signals input from the open state detection switch 102 or the closed state detection switch 103, by resetting the head of the HDD 105 at the data write/read enabled position over the disk.

When the portable telephone 100, having been in the closed state is being opened, the open state detection switch 102 enters an ON state as the opening angle becomes shy of the fully open state by the predetermined angle Δθ, as explained earlier. This means that if the CPU 104 moves the head of the HDD 105 to the data write/read enabled position as soon as the shift in the open state detection switch 102 from the OFF state to the ON state is detected, the shock attributable to the opening operation by the user will occur immediately after the data write/read at the HDD 105 is enabled and the hard disk will be subjected to the shock.

Accordingly, the CPU 104 moves the head of the HDD 105 to the data write/read enabled position when a predetermined length of time required by the portable telephone 100 to become fully opened elapses after detecting the shift in the open state detection switch 102 from the OFF state to the ON state. Namely, the CPU 104 moves the head of the HDD 105 to the data write/read enabled position only after the portable telephone 100 becomes fully open and thus, the HDD 105 is protected from the shock attributable to the opening operation performed by the user.

Likewise, when the portable telephone 100, having been in the open state is being closed, the closed state detection switch 103 enters an ON state when the opening angle becomes shy of the fully closed state by the predetermined angle Δθ. Accordingly, the CPU 104 sets the head of the HDD 105 to the data write/read enabled position when a predetermined length of time required by the portable telephone 100 to become fully closed elapses after the shift in the closed state detection switch 103 from the OFF state to the ON state is detected.

In other words, the CPU 104 moves the head of the HDD 105 to the data write/read enabled position only after the portable telephone 100 becomes fully closed and thus, the HDD 105 is protected from the shock attributable to the closing operation performed by the user.

FIG. 5 presents a flowchart of the processing executed in the portable telephone 100 in the embodiment. The processing in FIG. 5 is executed by the CPU 104 based upon a program started up with the timing with which data are written into the HDD 105. The data write timing as referred to in this context may be the timing with which image data obtained through an image capturing operation at the camera 101 are written into the HDD 105. In such a case, the CPU 104 first executes control on the image capturing operation in the camera 101 and then executes control for the image data write into the HDD 105. The CPU 104 executes the processing program in FIG. 5 when the image data are written into the HDD 105.

In step S10, a decision is made as to whether or not the open state detection switch 102 is in an ON state. If the open state detection switch 102 is determined to be in an ON state, the portable telephone 100 is judged to be in an open state and the operation proceeds to step S62. If, on the other hand, it is decided that the open state detection switch 102 is in an OFF state, the operation proceeds to step S20.

In step S20, a decision is made as to whether or not the closed state detection switch 103 is in an ON state. If the closed state detection switch 103 is determined to be in an ON state, the portable telephone 100 is judged to be in the closed state and the operation proceeds to step S62. If, on the other hand, it is decided that the closed state detection switch 103 is in an OFF state, the operation proceeds to step S30. In step S30, processing for writing data into the HDD 105 is disabled by assuming that a shock is about to occur due to an opening operation or a closing operation performed by the user. Subsequently, the operation proceeds to step S35.

In step S35, a head retract command is output to the HDD 105. Upon receiving the head retract command, the HDD 105 retracts the head to the safe position so as to prevent damage to the disk and the head and holds the head at the safe position. Then the operation proceeds to step S40.

In step S40, a decision is made again as to whether or not the closed state detection switch 103 is in an ON state. If the closed state detection switch 103 is determined to be in an ON state, the portable telephone 100 is judged to have shifted into a closed state and the operation proceeds to step S60 to be detailed later. If, on the other hand, the closed state detection switch 103 is determined to be in an OFF state, the operation proceeds to step S50.

In step S50, a decision is made again as to whether or not the open state detection switch 102 is in an ON state. If the open state detection switch 102 is determined to be in an ON state, the portable telephone 100 is judged to have shifted into an open state and the operation proceeds to step S60. If, on the other hand, the open state detection switch 102 is determined to be in an OFF state, the operation returns to step S40 by judging that the portable telephone 100 is neither in an open state nor in a closed state, i.e., the opening angle is in the range 3c in FIG. 4.

In step S60, to which the operation proceeds after judging that the portable telephone 100 has shifted into an open state or a closed state, a decision is made as to whether or not the predetermined length of time has elapsed, as explained earlier. If it is decided that the predetermined length of time has elapsed, the operation proceeds to step S62.

In step S62, a decision is made as to whether or not the head of the HDD 105 is in the retracted state. If it is decided in step S62 that the head of the HDD 105 is in the retracted state, the operation proceeds to step S66. In step S66, a head retract release command is output to the HDD 105 before the operation proceeds to step S70. Upon receiving the retracted head release command, the HDD 105 moves the head to the data write enabled position.

If, on the other hand, it is decided in step S62 that the head of the HDD 105 is currently set at the data write enabled position, the operation skips step S66 to proceed directly to step S70.

In step S70, data write processing at the HDD 105 is enabled, and then the operation proceeds to step S80. In step S80, a decision is made as to whether or not the data write processing at the HDD 105 has ended. If it is decided that the data write processing has not yet ended, the operation returns to step S10 to repeatedly execute the processing. If, on the other hand, it is decided that the data write processing at the HDD 105 has ended, the overall processing ends.

While the control processing described above is executed by the CPU 104 with regard to the timing with which data are written at the HDD 105, the CPU 104 executes similar processing with regard to the timing with which data are read from the HDD 105. The data read timing in this context may be timing with which image data stored at the HDD 105 are read out.

As the user performs a specific operation at the keyboard 107 to display a captured image, the keyboard 107 outputs an image display request signal to the CPU 104. Based upon the image display request signal, the CPU 104 controls the HDD 105 and reads out image data recorded therein. Then, the CPU 104 displays the image data having been read out onto the LCD 108. The timing with which the CPU 104 receives the image display request signal is equivalent to the data read timing. After receiving the image display request signal, the CPU 104 executes a processing program similar to that in FIG. 5.

It is to be noted that the flowchart of the processing executed at the read timing should be identical to the flowchart presented in FIG. 5 except that “data write” in steps S70 and S80 must be replaced with “data read”. Since the processing executed by the CPU 104 in the other steps is identical to that in the flowchart in FIG. 5, a detailed explanation is not provided.

The following advantages are achieved with the portable communication terminal in the embodiment described above.

(1) If an opening/closing operation performed by the user to open/close the portable telephone 100 is detected and the portable telephone 100 is expected to be subjected to a shock attributable to the opening/closing operation, data write/read at the HDD 105 is disabled and the head is retracted to the safe position so as to ensure that a malfunction attributable to the shock does not occur in the head or the disk. As a result, the HDD 105 is protected from the shock resulting from the opening/closing operation performed by the user to open/close the portable telephone 100.

(2) The open state detection switch 102 sustains an ON state until the portable telephone 100 having been in the fully open state becomes folded by the predetermined angle Δθ. In addition, the closed state detection switch 103 sustains an ON state until the portable telephone 100 having been in the fully closed state becomes opened by the predetermined angle Δθ. In other words, if the user briefly applies a force along the opening direction or the closing direction resulting in a slight change in the opening angle of the portable telephone 100, the change is not erroneously detected as an opening operation or a closing operation.

(3) After an opening operation or a closing operation performed by the user to open/close the portable telephone 100 is detected and the head of the hard disk is retracted, the head of the HDD 105 is moved back to the write/read enabled position if the portable telephone 100 is detected to have shifted into an open state or a closed state based upon the signals input from the open state detection switch 102 and the closed state detection switch 103. Thus, once the portable telephone 100 resumes a low risk state in which it is not likely to be subjected to a shock, the data write/read at the HDD 105 can be automatically resumed.

(4) The head of the HDD 105 is moved to the write/read enabled position only when the predetermined length of time has elapsed after detecting a shift in the open state detection switch 102 from an OFF state to an ON state. In other words, after detecting a shift in the open state detection switch 102 from the OFF state to the ON state, the operation waits for the portable telephone 100 to become fully open or fully closed before the head of the HDD 105 is allowed to move to the write/read enabled position. As a result, the HDD 105 is protected against any shock attributable to the opening/closing operation performed by the user.

—Variations—

It is to be noted that the portable communication terminal achieved in the embodiment described above allows for the following variations.

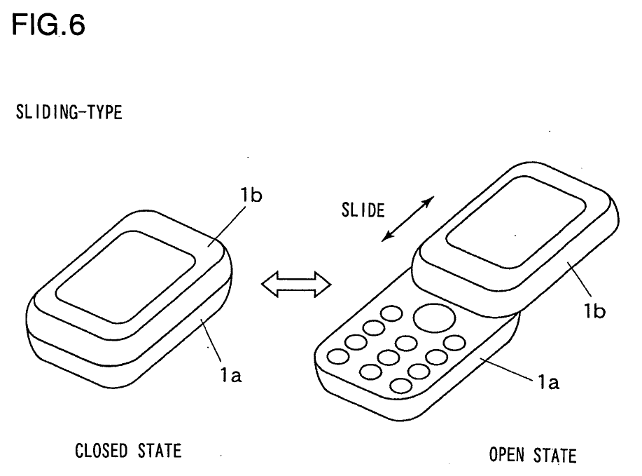

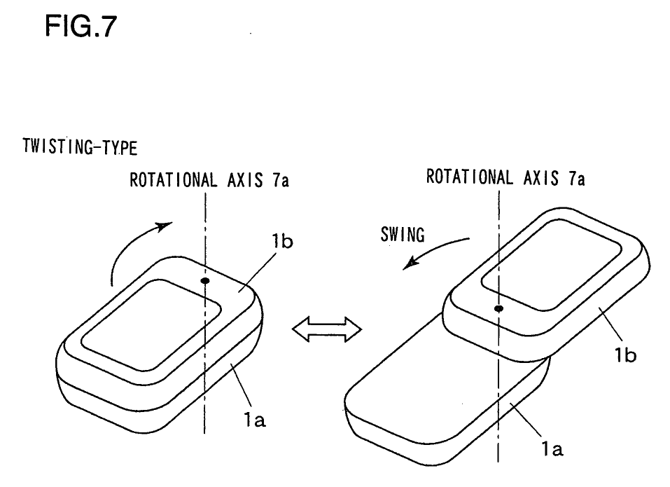

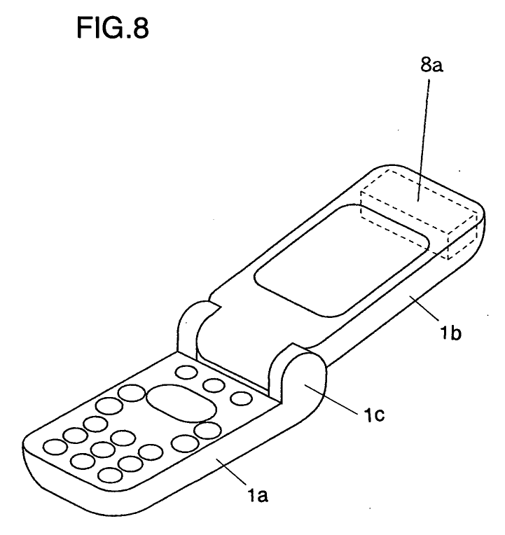

(1) An explanation is given above in reference to the embodiment on an example in which the portable telephone 100 is a folding-type portable telephone that includes the rotating hinge unit 1c functioning as an opening/closing mechanism and can be folded around the axis assumed at the rotating hinge unit 1c. In other words, the portable telephone 100 is opened/closed by folding the first body unit and the second body unit connected with each other via the opening/closing mechanism. However, the present invention is not limited to this example and it may be adopted in a sliding-type portable telephone, such as that shown in FIG. 6, which includes an opening/closing mechanism constituted with a slide mechanism that opens/closes the telephone as the keyboard-side body 1a and the LCD-side body 1b slide against each other. Alternatively, the present invention may be adopted in a twisting-type portable telephone such as that shown in FIG. 7, which includes an opening/closing mechanism constituted with a rotatable mechanism that opens/closes the telephone as the keyboard-side body 1a and the LCD-side body 1d rotate relative to each other around a rotational axis 7a. It is to be noted that the switches with which the open/closed state of the portable telephone is detected should be disposed within the slide mechanism in the sliding-type portable telephone in FIG. 6. In addition, the switches with which the open/closed state of the portable telephone is detected should be disposed within the rotatable mechanism in the twisting-type portable telephone in FIG. 7.

(2) An explanation is given above in reference to the embodiment on an example in which the closed state detection switch 103 is disposed at the keyboard-side body 1a. However, the present invention is not limited to this example and the closed state of the portable telephone 100 may be detected via a closed state detection switch similar to the open state detection switch 102, which is constituted with a built-in closed state detection electrode disposed within the rotating hinge unit 1c.

(3) In the embodiment described above, the open state detection switch 102 and the closed state detection switch 103 are used to detect the opening/closing operation performed by the user to open/close the portable telephone 100 and changes in the signals input from the individual switches are detected. However, the present invention is not limited to this example and the opening/closing operation performed by the user may instead be detected by using an acceleration sensor disposed within the portable telephone. For instance, the portable telephone may include a built-in acceleration sensor 8a disposed at an end of the LCD-side body 1b on the side opposite from the rotating hinge unit 1c. The opening/closing operation performed by the user to open/close the telephone may be detected as acceleration detected via the acceleration sensor 8a.

It is to be noted that the acceleration sensor 8a is provided as a built-in unit disposed at the end of the LCD-side body 1b on the side opposite from the rotating hinge unit 1c for the following reason. Namely, the user of the folding-type portable telephone will normally open/close the LCD body 1b around the axis assumed at the rotating hinge unit 1c while the keyboard-side body 1a is held still. Accordingly, since the peripheral velocity of the LCD-side body 1b as it is opened/closed along the rotating hinge unit 1c is greater at positions further away from the rotating hinge unit 1c, better detection accuracy is assured in detecting the opening/closing operation via the acceleration sensor 8a provided as a built-in unit at the end of the LCD-side body 1b on the side opposite from the rotating hinge unit 1c. Namely, it is more desirable to provide the acceleration sensor 8a as a built-in unit at a position at which the peripheral velocity of the LCD-side body 1b as it is opened/closed is equal to or greater than a predetermined value. It is to be noted that the acceleration sensor 8a may be provided as a built in unit disposed at the end of the keyboard-side body 1a on the side opposite from the rotating hinge unit 1c.

In addition, the acceleration sensor 8a may be mounted in the sliding-type portable telephone or the twisting-type portable telephone having been described in variation (1), to detect the opening/closing operation performed by the user. The acceleration sensor 8a should be provided as a built-in unit at the LCD-side body 1b in the sliding-type portable telephone, whereas the acceleration sensor 8a should be provided as a built-in unit in the twisting-type portable telephone at the end of the LCD-side body 1b on the side opposite from the rotational axis 7a, as in the folding-type portable telephone. Alternatively, the acceleration sensor 8a may be provided as a built-in unit disposed at the end of the keyboard-side body 1a on the side opposite from the rotational axis 7a.

(4) In the embodiment described above, if the portable telephone 100 is expected to be subjected to a shock upon detecting an opening/closing operation performed by the user to open/close the portable telephone 100, the head of the HDD 105 is retracted. In conjunction with this feature, the image data to be written may be transferred to and saved at an outside server through wireless communication executed via the communication device 106 while the head of the HDD 105 is held at the retracted position. Namely, when data write at the HDD 105 is disabled, image data storage may be switched from the HDD 105 to an outside server, a connection with which can be established through wireless communication via the communication device 106.

(5) While the processing in the program shown in FIG. 5 is executed with the timing with which data are written or read at the HDD 105 in the embodiment described above, the present invention is not limited to this example. Namely, the CPU 104 may constantly monitor the states of the open state detection switch 102 and the closed state detection switch 103 in order to detect an opening/closing operation performed by the user, as long as the power to the portable telephone 100 is in an on state. Then, upon detecting an opening/closing operation by the user, the CPU 104 should retract the head of the HDD 105. More specifically, a processing program that does not include the processing in steps S70 and S80 in the flowchart in FIG. 5 and returns to step S10 upon completing the processing in step S66 may be executed at all times. In such a case, step S30 should be executed to disable data write processing and data read processing.

(6) An explanation is given above in reference to the embodiment on an example in which image data obtained by capturing an image with the camera 101 are stored into the HDD 105. However, the present invention is not limited to this example and it may be adopted when storing data downloaded via the communication device 106 into the HDD 105 or when storing data entered by the user into the HDD 105.

(7) While an explanation is given above in reference to the embodiment on an example in which the portable communication terminal is achieved as a portable telephone, the present invention is not limited to this example and it may be adopted in other types of portable devices having other communication functions, such as a PDA.

It is to be noted that the embodiment described above simply represents an example and the present invention is in no way limited to this example as long as the functions characterizing the present invention remain intact.

What is claimed is:

1. A portable communication terminal, comprising:
a first body unit;
a second body unit;
an opening/closing mechanism used to open/close the first body unit and the second body unit relative to each other;
a hard disk drive at which data written onto a disk by using a head are stored;
a predicting device that detects opening operation/closing operation of the opening/closing mechanism and predicts occurrence of a shock attributable to at least one of the opening operation and the closing operation; and
a control device that retracts the head of the hard disk drive to a safe position so as to ensure that neither the disk nor the head becomes damaged, based upon a prediction of occurrence of shock by the predicting device.

2. A portable communication terminal according to claim 1, wherein:
the predicting device detects the opening operation of the opening/closing mechanism by detecting that the opening/closing mechanism, having been in a closed state, has become opened by a predetermined extent.

3. A portable communication terminal according to claim 1, wherein:
the predicting device detects the closing operation of the opening/closing mechanism by detecting that the opening/closing mechanism, having been in a open state, has become closed by a predetermined extent.

4. A portable communication terminal according to claim 1, wherein:
the opening/closing mechanism is any of; a mechanism that opens/closes by allowing the first body unit and the second body unit to slide relative to each other, a mechanism that opens/closes by allowing the first body unit and the second body unit to fold relative to each other and a mechanism that opens/closes by allowing the first body unit and the second body unit to twist relative to each other.

5. A portable communication terminal according to claim 1, further comprising:
a state detection device that detects at least one of an open state and a closed state of the opening/closing mechanism, wherein:
the control device sets the head of the hard disk drive at a position at which write to disk is enabled, if the state detection device detects the open state or the closed state of the opening/closing mechanism.

6. A portable communication terminal according to claim 1, further comprising:
a state detection device that detects at least one of an open state and a closed state of the opening/closing mechanism, wherein:
the control device sets the head of the hard disk drive at a position at which read from disk is enabled, if the state detection device detects the open state or the closed state of the opening/closing mechanism.

7. A portable communication terminal according to claim 1, further comprising:
a state detection device that detects at least one of an open state and a closed state of the opening/closing mechanism, wherein:
if the state detection device detects the open state or the closed state at the opening/closing mechanism while the head is held at the safe position, the control device moves the head of the hard disk drive to a position at which a write into the disk is enabled.

8. A portable communication terminal according to claim 1, further comprising:
a state detection device that detects at least one of an open state and a closed state of the opening/closing mechanism, wherein:
if the state detection device detects the open state or the closed state at the opening/closing mechanism while the head is held at the safe position, the control device moves the head of the hard disk drive to a position at which a read from the disk is enabled.

9. A portable communication terminal according to claim 1, wherein:
the predicting device includes a detection device that detects the opening operation/closing operation of the opening/closing mechanism.

10. A portable communication terminal according to claim 9, wherein:
the detection device includes an acceleration sensor.

11. A portable communication terminal according to claim 4, wherein:
the predicting device includes an acceleration sensor;
if the opening/closing mechanism opens/closes as the first body unit and the second body unit are allowed to fold relative to each other, the acceleration sensor is disposed at least at one of an end of the first body unit located on a side opposite from a rotational center of the opening/closing mechanism and an end of the second body unit located on a side opposite from the rotational center of the opening/closing mechanism; and
if the opening/closing mechanism opens/closes as the first body unit and the second body unit are allowed to twist relative to each other, the acceleration sensor is disposed at least at one of an end of the first body unit located on a side opposite from a center of a rotating motion of the opening/closing mechanism and an end of the second body unit located on a side opposite from the center of the rotating motion of the opening/closing mechanism.

12. A portable communication terminal according to claim 1, further comprising:
a switching device that switches a data storage location to an external storage device connected via a wireless communication device based upon a prediction of occurrence of shock by the predicting device.

13. A portable communication terminal according to claim 1, further comprising:
an image-capturing device that captures an image, wherein:
image data obtained by capturing the image at the image-capturing device are stored into the hard disk drive.
